(19) United States
(12) Patent Application Publication
(10) Pub. No.: US 2010/0140436 A1
(43) Pub. Date: Jun. 10, 2010

(54) ADJUSTING DEVICE WITH A DIMINUTIVE POSITIONING ASSEMBLY

(76) Inventor: Mu-Chuan WU, Tainan Hsien (TW)

Correspondence Address: Hershkovitz & Associates, LLC, 2845 Duke Street, Alexandria, VA, 22314, US

(21) Appl. No.: 12/359,170

(22) Filed: Jan. 23, 2009

(30) Foreign Application Priority Data
Dec. 10, 2008 (TW) 097222113

(51) Int. Cl. F16M 13/00

(52) U.S. Cl. 248/354.4; 248/354.5

(57) ABSTRACT

An adjusting device with a diminutive adjustment has an inner tube, an outer tube, an adjusting seat, and a diminutive positioning assembly. The inner tube is movably mounted in the outer tube. The outer tube has a through hole. The adjusting seat is mounted on the outer tube and covers the through hole of the outer tube and has a recess. The diminutive positioning assembly is mounted in the recess of the adjusting seat and has an operating tab. It is convenient and safe to operate the operating tab to diminutively position tan armrest the support or the like of a chair or an exercise machine.

### BACKGROUND OF THE INVENTION

1. Field of the Invention

The present invention relates to an adjusting device, and more particularly to an adjusting device with a diminutive positioning assembly for chairs, exercise machines, etc.

2. Description of the Prior Arts

An adjusting device is mounted on an armrest, a support or the like of a chair or an exercise machine to allow different users to adjust the armrest, the support or the like to a suitable height.

Conventional adjusting devices are divided into two kinds a discrete mechanism and analog mechanism.

The discrete mechanism has an inner tube and an outer tube. The inner tube has multiple positioning holes spaced at equal intervals. The outer tube is mounted around the inner tube and has a bolt. The inner tube moves up and down along the outer tube for adjustment to a suitable height. Then the bolt is inserted in corresponding positioning holes to hold the inner tube at the suitable height. The distance between adjacent positioning holes determines the adjustable heights of the inner tube. However, the heights of the inner tube are limited at certain heights because the distance between adjacent positioning holes is fixed and the number of the positioning holes is also limited. The user cannot adjust the height of the inner tube to any desired height.

Further, the analog mechanism has an outer tube and an inner tube. The outer tube has a fastener to hold the inner tube at any desired height by friction between the fastener and the inner tube. However, the friction between the fastener is easily lost due to external forces so the height of the inner tube is not firmly fixed and may be unsafe or require frequent readjustment.

To overcome the shortcomings, the present invention provides an adjusting device with a diminutive positioning assembly to mitigate or obviate the aforementioned problems.

### SUMMARY OF THE INVENTION

The main objective of the invention is to provide an adjusting device with a diminutive positioning assembly overcoming the problems or shortcomings of the conventional adjusting device.

An adjusting device with diminutive adjustment has an inner tube, an outer tube, an adjusting seat, and a diminutive positioning assembly. The inner tube is movably mounted in the outer tube. The outer tube has a through hole. The adjusting seat is mounted on the outer tube and covers the through hole of the outer tube and has a recess. The diminutive positioning assembly is mounted in the recess of the adjusting seat and has an operating tab. It is convenient and safe to operate the operating tab to diminutively position an armrest, support or the like of a chair of an exercise machine to a suitable height.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of an adjusting device with a diminutive positioning assembly in accordance with the present invention;

FIG. 2 is a perspective view of the adjusting device with a diminutive positioning assembly in FIG. 1;

FIG. 3 is a top view in partial section of the adjusting device with a diminutive positioning assembly in FIG. 1;

FIG. 4 is a top view in partial section of a second embodiment of the adjusting device with a diminutive positioning assembly in accordance with the present invention;

FIG. 5 is a top view in partial section of a third embodiment of the adjusting device with a diminutive positioning assembly in accordance with the present invention;

FIG. 6 is a top view in partial section of a fourth embodiment of the adjusting device with a diminutive positioning assembly in accordance with the present invention;

FIG. 7 is an operational top view in partial section of the adjusting device with a diminutive positioning assembly in FIG. 1, showing a step adjustment;

FIG. 8 is an operational top view in partial section of the adjusting device with a diminutive positioning assembly in FIG. 1, showing a diminutive adjustment; and

FIG. 9 is an operational side view in partial section of the adjusting device with a diminutive positioning assembly in FIG. 1, showing a diminutive adjustment.

### DETAILED DESCRIPTION OF THE PREFERRED EMBODIMENTS

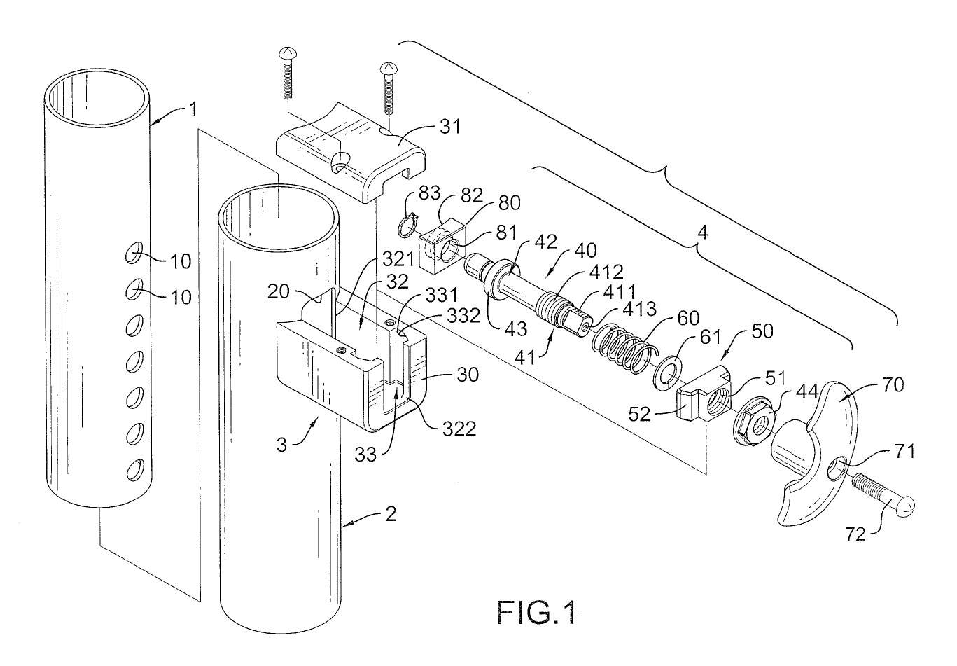

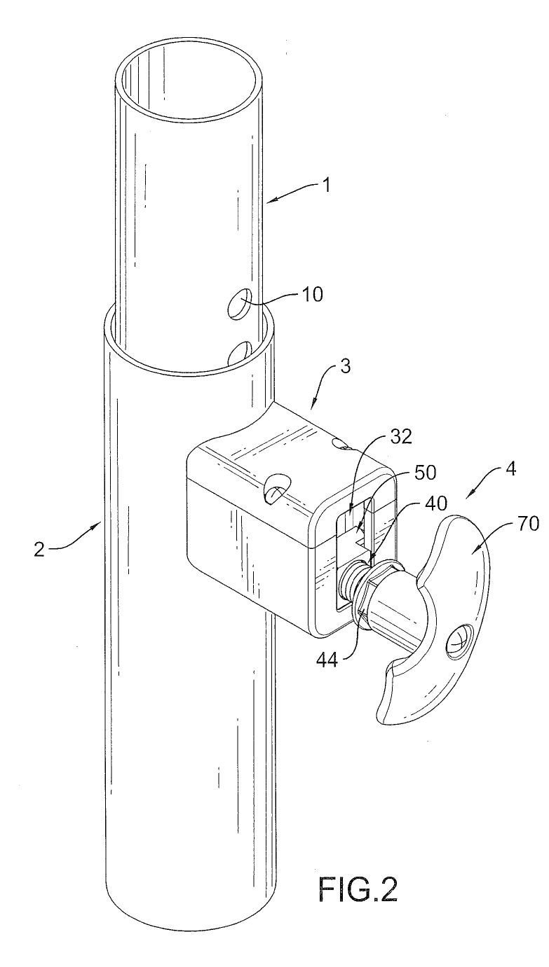

With reference to FIGS. 1 and 2, an adjusting device with a diminutive positioning assembly in accordance with the present invention comprises an inner tube (1), an outer tube (2), an adjusting seat (3) and a diminutive positioning assembly (4).

The inner tube (1) has a tube wall, multiple positioning holes (10) and an exterior surface. The positioning holes (10) are formed through the tube wall of the inner tube (1) at intervals.

The outer tube (2) is mounted movably around the inner tube (1) and has a tube wall and a through hole (20). The through hole (20) is formed through the tube wall of the outer tube (2) and selectively aligns with any two adjacent positioning holes (10) of the inner tube (1).

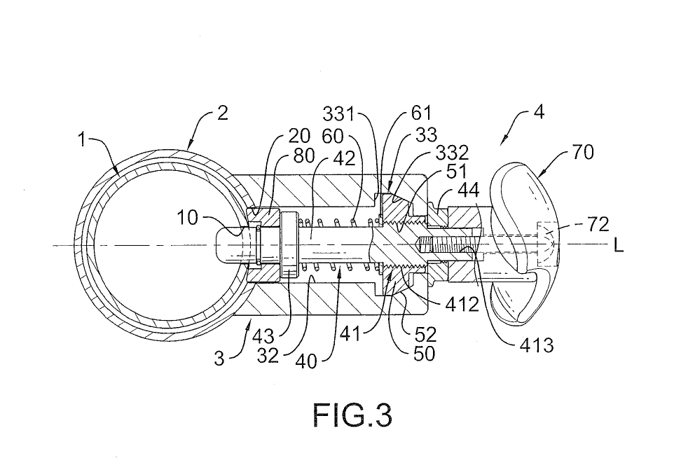

With further reference to FIG. 3, the adjusting seat (3) is attached securely to the tube wall of the outer tube (2), corresponds to the through hole (20) of the outer tube (2) and has two ends, a recess (32) and a clutch segment (33). The recess (32) is formed through the adjusting seat (3) from the one end to the other end and communicates with the through hole (20) of the outer tube (2) and has an inner sidewall and a center line. The inner sidewall is formed around the recess (32). The clutch segment (33) is formed in the recess (32).

In a preferred embodiment, the adjusting seat (3) has a body (30) and a cover (31). The cover (31) covers the body (30) and is fastened by screws, adhesive or the like. The adjusting seat (3) may be two half pieces connected to each other.

The recess (32) further has an inner opening (321) and an outer opening (322). The inner opening (321) corresponds to and communicates with the through hole (20) of the outer tube (2).

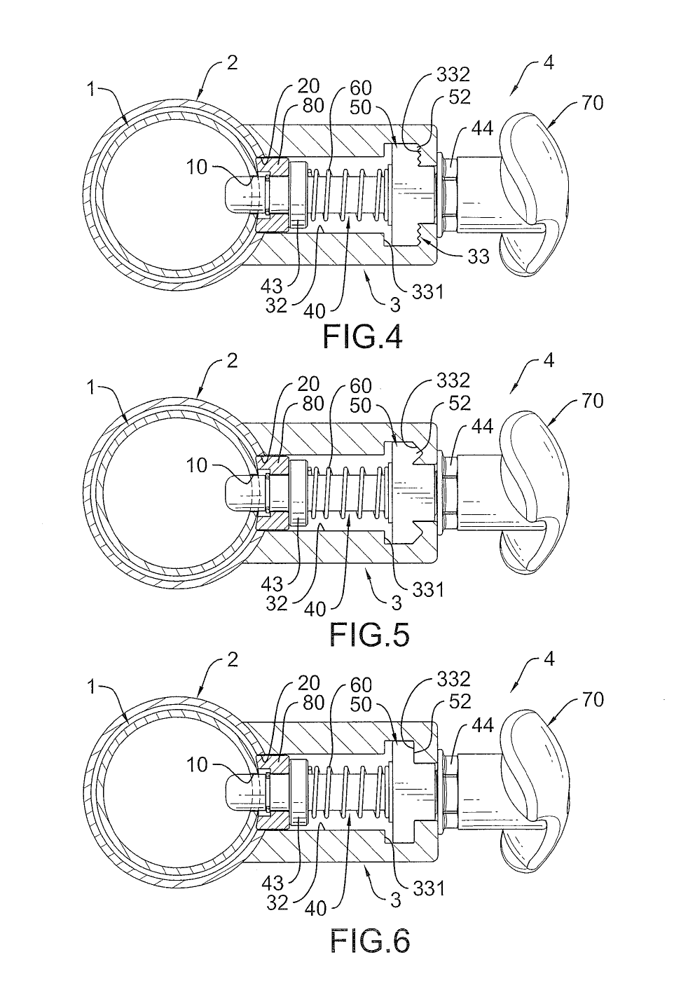

With reference to FIGS. 1, 3 to 6, the clutch segment (33) is formed adjacent to the outer opening (322) of the recess (32) and may comprise two notches (331). The notches (331) are formed in the inner sidewall of the recess (32) of the adjusting seat (3). Each notch (331) has an actuating surface (332) defined on the sidewall of the recess (32). The actuating surface (332) may be perpendicular to the center line of the recess (32), may be inclined, or may be V-shaped, and may have multiple teeth as shown in FIGS. 4 to 6.

The diminutive positioning assembly (4) is mounted in the adjusting seat (3) to fasten the outer tube (2) and the inner tube (1) and has a positioning shaft (40), a diminutive clutch (50), a spring (60) and an operating tab (70).

The positioning shaft (40) is mounted movably through the recess (32) of the adjusting seat (3) and has a positioning part (42) and a connecting part (41). The positioning part (42) is mounted movably in the recess (32) of the adjusting seat (3) and has an outer end. The connecting part (41) is formed on and protrudes out from the outer end of the positioning part (42), is mounted movably through the recess (32) of the adjusting seat (3) and has an inner end and an outer end. The inner end of the connecting part (41) selectively protrudes out of the recess (32). The outer end of the connecting part (41) protrudes out of the recess (32).

The diminutive clutch (50) is mounted around the positioning part (42) of the positioning shaft (40), is mounted movably in the clutch segment (33) of the adjusting seat (3) and has an actuating surface (52). The actuating surface (52) 1 corresponds to and selectively engages the actuating surface (332) of the clutch segment (33). The actuating surface (52) of the diminutive clutch (50) may be perpendicular to the center line of the recess (32), may be inclined, or may be V-shaped, and may have multiple teeth as shown in FIGS. 4 to 6.

The spring (60) is mounted around the positioning part (42) of the positioning shaft (40) and abuts against the diminutive clutch (50).

The operating tab (70) is attached securely to the outer end of the connecting part (41) of the positioning shaft (40).

With reference to FIGS. 1 and 3, in a preferred embodiment, a washer (61) is mounted around the positioning shaft (40) and is mounted between the spring (60) and the diminutive clutch (50).

In a preferred embodiment, an annular flange (43) protrudes radially around the positioning part (42) of the positioning shaft (40). The spring (60) is mounted between the annular flange (43) and the diminutive clutch (50). The diminutive positioning assembly (4) further has a spacer (80). The spacer (80) is mounted through the through hole (20) of the outer tube (2) and abuts the exterior surface of the inner tube (1) and has a mounting hole (81), an abutting surface (82) and a ring (83). The mounting hole (81) is mounted around the positioning part (42) of the positioning shaft (40). The abutting surface (82) selectively abuts the inner tube (1) and may be curved.

In the preferred embodiment, the connecting part (41) of the positioning shaft (40) further has a threaded hole (413). The threaded hole (413) is formed axially in the outer end of the connecting part (41). The operating tab (70) has a center hole (71) and a screw (72). The screw (72) is mounted through the center hole (71) and screwed into the threaded hole (413) of the connecting part (41) to fasten the operating tab (70) on the outer end of the connecting part (41) of the positioning shaft (40).

In the preferred embodiment, the connecting part (41) of the positioning shaft (40) further has an outer thread part (411) and an inner thread part (412). The outer thread part (411) is formed around the outer end of the connecting part (41) and has a diameter. The inner thread part (412) is formed around the inner end of the connecting part (41) and has a diameter. The diameter of the inner thread part (412) is larger than the diameter of the outer thread part (411). The diminutive clutch (50) has a threaded hole (51). The threaded hole (51) is formed in the diminutive clutch (50) and is screwed onto the inner threaded part (412) of the connecting part (41). The positioning shaft (40) further has a nut (44). The nut (44) is screwed onto the outer thread part (411) and is mounted between the operating tab (70) and the diminutive clutch (50).

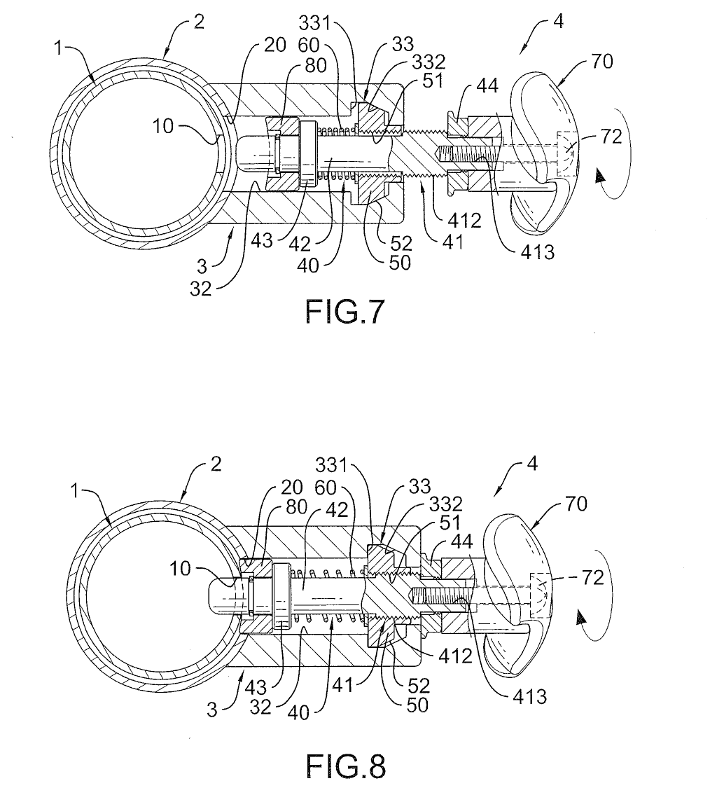

With further reference to FIG. 7,A discrete adjustment is made by rotating the operating tab (70) in a non-drive direction to drive the nut (44) of the diminutive positioning assembly (4) and the operating tab (70) be distant from adjusting seat (3) and the distal end of the positioning part (42) of the positioning shaft (40) disengage the positioning hole (10) of the inner tube (1). Then, moving the inner tube (1) along the outer tube (2) up and down to adjust an appropriate position. When the inner tube (1) is moved to a suitable height, rotating the operating tab (70) in a drive direction causes the distal end of the positioning part (42) to be inserted in the corresponding positioning hole (10) of the inner hole (10) and the nut (44)to abut the adjusting seat (3).

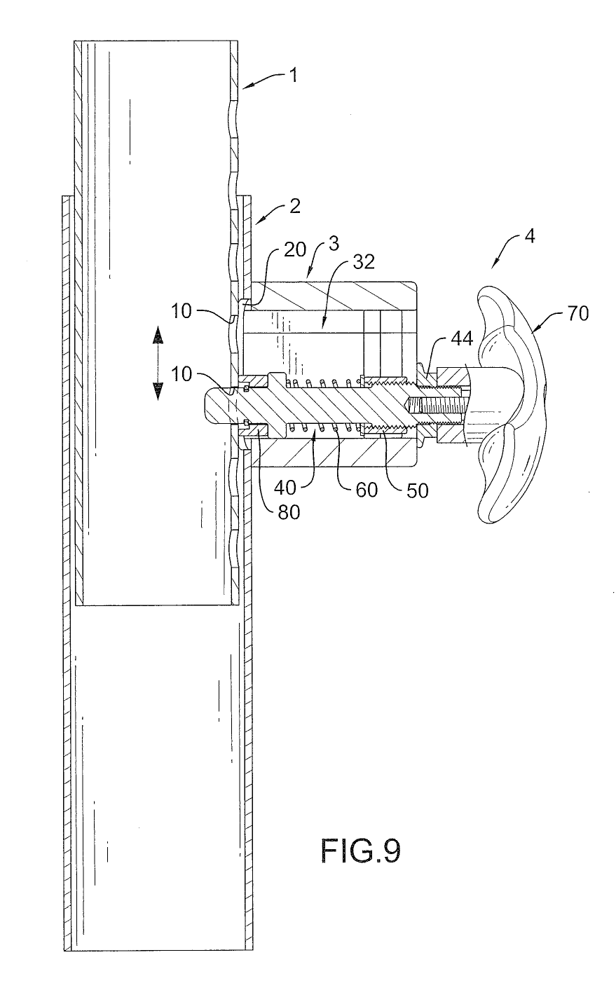

When the discrete adjustment cannot adjust the most suitable height, a diminutive adjustment is made. With further reference to FIGS. 8 and 9, rotating the operating tab (70) in a non-drive direction slightly to drive the nut (44) to be distant from the adjusting seat (3) at a little interval, and the positioning part (42) of the positioning shaft (40) keeps inserting in the positioning hole (10) of the inner tube (1). Then, pressing the operating tab (70) inward to drive the actuating surface (52) of the diminutive positioning assembly (4) to disengage the actuating surface (332) of the clutch segment (33) of the adjusting seat (3) and make the nut (44) abutting against the adjusting seat (3). Then, moving the operating tab (70) up and down driving the inner tube (1) to adjust to a suitable height. When the inner tube (1) has been moved to the suitable height, rotating the operating tab (70) in a drive direction to drive the actuating surface (52) of the diminutive positioning assembly (4) engaged the actuating surface (332) of the clutch segment (33) of the adjusting seat (3). The positioning shaft (40) is securely held in the adjusting seat (3) by one end of the adjusting seat (3) being squeezed securely between the actuating surface (52) of the diminutive positioning assembly (4) and the nut (44) and the spring force provide by the spring (60).

The through hole (20) of the outer tube (2) contains a range of any two adjacent through hole (10) of the inner tube (1) and limits movement of the positioning shaft (40) and the spacer (80) so when the diminutive clutch (50) disengages the clutch segment (33) of the adjusting seat (3) by external force, the inner tube (1) will not descend in by a large change so improving safety.

Therefore, the adjusting device with a diminutive positioning assembly in accordance with the present invention combines robustness of a discrete mechanism and flexibility of an analog mechanism to provide more convenient procedure to diminutive and position the suitable height of a hand hold, support or the other adjusting mechanism.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An adjusting device comprising:
an inner tube having
a tube wall;
multiple positioning holes formed through the tube wall of the inner tube at intervals; and
an exterior surface;
an outer tube mounted movably around the inner tube and having
a tube wall; and
a through hole formed through the tube wall of the outer tube and selectively aligning with any two adjacent positioning holes of the inner tube;
an adjusting seat attached securely to the tube wall of the outer tube, corresponding to the through hole of the outer tube and having
a recess formed through the adjusting seat, communicating with the through hole of the outer tube and having
an inner sidewall; and
a center line;
a clutch segment formed in the recess; and
a diminutive positioning assembly mounted in the adjusting seat to fasten the outer tube and the inner tube and having
a positioning shaft having
a positioning part mounted movably in the recess of the adjusting seat and having
an outer end; and
a connecting part formed on and protruding out from the outer end of the positioning part and having
an outer end; and
an inner end; and
a diminutive clutch mounted around the positioning part of the positioning shaft and mounted movably in the clutch segment of the adjusting seat;
a spring mounted around the positioning part of the positioning shaft and abutting the diminutive clutch; and
an operating tab attached securely to the outer end of the connecting part of the positioning shaft.

2. The adjusting device as claimed in claim 1, wherein
the recess of the adjusting seat further has an inner opening and an outer opening;
the clutch segment of the adjusting seat is formed adjacent to the outer opening of the recess of the adjusting seat and has two notches formed in the inner sidewall of the recess of the adjusting seat, and each notch having an actuating surface; and
the diminutive clutch has an actuating surface corresponding to and selectively engaging the actuating surface of the clutch segment.

3. The adjusting device as claimed in claim 2, wherein the actuating surface of the diminutive clutch is perpendicular to the center line of the recess of the adjusting seat.

4. The adjusting device as claimed in claim 2, wherein the actuating surface of the diminutive clutch is inclined.

5. The adjusting device as claimed in claim 2, wherein the actuating surface of the diminutive clutch is V-shaped.

6. The adjusting device as claimed in claim 2, wherein the actuating surface of the diminutive clutch has multiple teeth.

7. The adjusting device as claimed in claim 3, wherein the actuating surface of the diminutive clutch has multiple teeth.

8. The adjusting device as claimed in claim 4, wherein the actuating surface of the diminutive clutch has multiple teeth.

9. The adjusting device as claimed in claim 5, wherein the actuating surface of the diminutive clutch has multiple teeth.

10. The adjusting device as claimed in claim 1, wherein
the connecting part of the positioning shaft further has
an outer thread part formed around the outer end of the connecting part of the positioning shaft and having a diameter; and
an inner thread part formed around the inner end of the connecting part of the positioning shaft and having a diameter being larger than the diameter of the outer thread part; and
a nut is screwed onto the outer thread part and is mounted between the operating tab and the diminutive clutch.

11. The adjusting device as claimed in claim 2, wherein
the connecting part of the positioning shaft further has
an outer thread part formed around the outer end of the connecting part of the positioning shaft and having a diameter; and
an inner thread part formed around the inner end of the connecting part of the positioning shaft and having a diameter being larger than the diameter of the outer thread part; and
a nut is screwed onto the outer thread part and is mounted between the operating tab and the diminutive clutch.

12. The adjusting device as claimed in claim 3, wherein
the connecting part of the positioning shaft further has
an outer thread part formed around the outer end of the connecting part of the positioning shaft and having a diameter; and
an inner thread part formed around the inner end of the connecting part of the positioning shaft and having a diameter being larger than the diameter of the outer thread part; and
a nut is screwed onto the outer thread part and is mounted between the operating tab and the diminutive clutch.

13. The adjusting device as claimed in claim 4, wherein
the connecting part of the positioning shaft further has
an outer thread part formed around the outer end of the connecting part of the positioning shaft and having a diameter; and
an inner thread part formed around the inner end of the connecting part of the positioning shaft and having a diameter being larger than the diameter of the outer thread part; and
a nut is screwed onto the outer thread part and is mounted between the operating tab and the diminutive clutch.

14. The adjusting device as claimed in claim 5, wherein
the connecting part of the positioning shaft further has
an outer thread part formed around the outer end of the connecting part of the positioning shaft and having a diameter; and
an inner thread part formed around the inner end of the connecting part of the positioning shaft and having a diameter being larger than the diameter of the outer thread part; and
a nut is screwed onto the outer thread part and is mounted between the operating tab and the diminutive clutch.

15. The adjusting device as claimed in claim 6, wherein
the connecting part of the positioning shaft further has
an outer thread part formed around the outer end of the connecting part of the positioning shaft and having a diameter; and
an inner thread part formed around the inner end of the connecting part of the positioning shaft and having a diameter being larger than the diameter of the outer thread part; and
a nut is screwed onto the outer thread part and is mounted between the operating tab and the diminutive clutch.

16. The adjusting device as claimed in claim 7, wherein
the connecting part of the positioning shaft further has
an outer thread part formed around the outer end of the connecting part of the positioning shaft and having a diameter; and
an inner thread part formed around the inner end of the connecting part of the positioning shaft and having a diameter being larger than the diameter of the outer thread part; and
a nut is screwed onto the outer thread part and is mounted between the operating tab and the diminutive clutch.

17. The adjusting device as claimed in claim 10, wherein the diminutive positioning assembly further has a spacer mounted through the through hole of the outer tube and abutting the exterior surface of the inner tube and having
a mounting hole mounted around the positioning part of the positioning shaft; and
an abutting surface selectively abutting the inner tube and being curved.

18. The adjusting device as claimed in claim 17, wherein the positioning shaft further has an annular flange protruding radially around the positioning part of the positioning shaft.

19. The adjusting device as claimed in claim 18, wherein
the connecting part further has a threaded hole formed axially in the outer end of the connecting part; and
the operating tab has
a center hole; and
a screw mounted through the center hole and screwed into the threaded hole of the connecting part.

20. The adjusting device as claimed in claim 19, wherein the adjusting seat further has
a body; and
a cover covering the body and fastened by screws.
